(19) United States
(12) Patent Application Publication
(10) Pub. No.: US 2006/0167600 A1
(43) Pub. Date: Jul. 27, 2006

(54) Architecturally partitioned automatic steering system and method

(75) Inventors: Robert Leonard Nelson JR., Austin, TX (US); James F. Hughen, Austin, TX (US); David A. Fowler, Elgin, TX (US)

Correspondence Address: ALTERA LAW GROUP, LLC, 6500 CITY WEST PARKWAY, SUITE 100, MINNEAPOLIS, MN, 55344-7704, US

(73) Assignee: Raven Industries, Inc., Sioux Falls, SD (US)

(21) Appl. No.: 11/046,498

(22) Filed: Jan. 27, 2005

(51) Int. Cl. G06F 19/00

(52) U.S. Cl. 701/23; 701/50; 701/41

(57) ABSTRACT

A system and method for automatically steering a vehicle along an intended path is provided. The system is architecturally partitioned. The partitioned design allows each of the system elements to be designed and maintained independently while allowing variation and flexibility in system configuration. An embodiment of the system elements may comprise a local navigation guidance unit, an external positioning system, a steering controller, and an installation and service computer. Additional elements of an embodiment of the system may comprise a steering position sensor, and at least one steering actuator. The system allows the operator to enter an intended target path and certain vehicle parameters. The local navigation guidance unit receives positional data from an external positioning system, preferably DGPS, indicative of a navigational path traversed by the vehicle. The guidance unit compares the positional data with the intended target path to obtain guidance error and transmits the guidance error to the steering controller. The system allows for determination of the current steering angle and generation of a steering angle adjustment based upon the intended target, the navigational path traversed by the vehicle, the vehicle parameters, the steering angle and the guidance error. The steering angle adjustment is used to actuate a steering mechanism to smoothly guide the vehicle along the intended target path.

### FIELD OF THE INVENTION

This invention relates generally to a system and method for automatically steering a vehicle along an intended target path.

### BACKGROUND OF THE PRESENT INVENTION

Assisted steering systems are currently used in applications where vehicles and equipment must be moved across the surface of the ground or water in a precise path to increase operating efficiency and to reduce operator fatigue and error. For example, agricultural equipment for spraying crops would be guided to traverse parallel paths (swaths) of equal width across a field. Such guidance equipment display information to assist the operator in keeping the equipment on the correct path/swath.

In the current state of the art, the assisted steering modules are designed as integrated units without architectural partitioning. This creates several problems. Such unpartitioned units do not allow for safety warnings and/or indications to be displayed to the operator by more than one modality. Such units further do not allow individualized design of the system components to allow element-by-element upgrades to the system. The unpartitioned units also fail to provide for individual system element maintenance and/or replacement if an element malfunctions or requires service. Such units are inherently limited in that they do not allow for variation of system element configuration as technology advances. If a technological advance regarding a particular system element becomes available, it becomes necessary with the current state of the art units to replace the entire integrated unit to achieve enhanced performance. Further, current systems do not allow use of the integrated unit with different DGPS receivers. Finally, such systems do not allow data flow from a local navigation guide, in the preferred embodiment a light bar, to a steering controller and from the steering controller to the light bar; data flow necessary to achieve maximal performance.

The inventive embodiments disclosed and claimed herein utilize a preferred embodiment whereby GPS and DGPS signals are utilized, although it will be clear to those skilled in the art that any navigational system will work in the inventive system and method as long as it provides real-time positional solutions.

GPS is a satellite-based global navigation system created and operated by the United States Department of Defense (DOD). Originally intended solely to enhance military defense capabilities, GPS capabilities have expanded to provide highly accurate position and timing information for many civilian applications.

Generally, twenty-four satellites in six orbital paths circle the earth twice each day at an inclination angle of approximately 55 degrees to the equator. This constellation of satellites continuously transmits coded positional and timing information at high frequencies in the 1500 Megahertz range. GPS receivers with antennas located in a position to clearly view the satellites pick up these signals and use the coded information to calculate a position in an earth coordinate system. GPS can, however, exhibit significant error. GPS receivers determine position by calculating the time it takes for the radio signals transmitted from each satellite to reach earth.

Thus, the positional accuracy of the GPS system depends upon the receiver's ability to accurately calculate the time it takes for each satellite signal to travel to earth. There are primarily five sources of errors in this time calculation that may affect the receiver's calculation accuracy. These errors are: (1) ionosphere and troposphere delays on the radio signal; (2) signal multi-path; (3) receiver clock biases; (4) orbital satellite (ephemeris) position errors; and (5) intentional degradation of the satellite signal by the DOD, i.e., selective availability.

Many of these errors may be reduced or eliminated through a technique known as differential GPS (DGPS). DGPS works by placing a high-performance GPS receiver (reference station) at a known location, generally onshore. Since the receiver knows its exact location, it can determine the errors in the satellite signals. The receiver does this by measuring the ranges to each satellite using the signals received and comparing these measured ranges to the actual ranges calculated from its known position. The difference between the measured and calculated range is the total error. The error data for each tracked satellite is formatted into a correction message and transmitted to GPS users. These differential corrections are then applied to the GPS calculations, thus removing most of the satellite signal error and improving accuracy. The level of accuracy obtained is a function of the DGPS receiver, but may be in the submeter range.

In the FAA Wide Area Augmentation System (WMS), the corrected differential message is broadcast through one of two geostationary satellites, via a wide area master station having a known location which may further improve the accuracy of the position solutions provided by the DGPS receiver.

WMS provides coverage only in the United States and some portions of Canada. Europe has an analogous system called EGNOS and Japan's system is referred to as MTSAT.

Submeter accuracy may be achieved through WAAS or the DGPS radiobeacons maintained by the U.S. Coast Guard without a subscription fee. Commercial satellite corrections services such as HP Omnistar and Omnistar VBS may be utilized to achieve submeter accuracies.

Real-time kinematic (RTK) corrections allow accuracy in the centimeter range. RTK uses a base receiver, often placed in the corner of a field, and roving receiver on the vehicle of interest. Both receivers gather data from some of the twenty-four orbiting satellites. The base receiver also sends corrections to the roving receiver, to achieve real-time centimeter range accuracy.

The inventive system and method described below are fully capable of operation using any navigational system or external positioning system.

### SUMMARY OF THE INVENTION

A system and method for automatically steering a vehicle along an intended path. The system is architecturally partitioned. The partitioned design allows each of the system elements to be designed and maintained independently while allowing variation and flexibility in system configuration. An embodiment of the system elements may comprise a local navigation guidance unit, an external positioning system, a steering controller, and an installation and service computer. Additional elements of an embodiment of the system may comprise a steering position sensor, and at least one steering actuator. The system allows the operator to enter an intended target path and certain vehicle parameters. The local navigation guidance unit receives positional data from an external positioning system, preferably DGPS, via communication switching in the steering controller that is indicative of a navigational path traversed by the vehicle. The guidance unit compares the positional data with the intended target path to obtain guidance error and transmits the guidance error to the steering controller. The system allows for determination of the current steering angle and generation of a steering angle adjustment based upon the intended target, the navigational path traversed by the vehicle, the vehicle parameters, the steering angle and the guidance error. The steering angle adjustment is used to actuate a steering mechanism to smoothly guide the vehicle along the intended target path.

An advantage of an embodiment of the invention is to provide an architecturally partitioned system that allows the system elements to be independently designed and maintained.

An advantage of another embodiment of the invention is to provide an architecturally partitioned system that allows ease of variation in system configuration.

An advantage of another embodiment of the invention is to provide architecturally partitioned local navigational guide and steering controller system elements that are compatible with virtually any DGPS-enabled receiver.

Yet another advantage of another embodiment of the invention is a system that allows safety warnings and/or indications to be displayed by more than one element of the system.

Still another advantage of an embodiment of the invention is a system that allows data flow from a local navigation guide, in the preferred embodiment a light bar, to a steering controller and from the steering controller to the light bar to achieve maximal performance.

Another advantage of an embodiment of the invention is a system and method that allows communication between architecturally partitioned components via switching communication in the steering controller.

Another advantage of an embodiment of the invention is providing a system that allows modification of steering control methods based on existing operating experience.

The foregoing advantages of various embodiments of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a schematic diagram of the system architecture.

FIG. 2 is a flowchart of the general method for a vehicle with at least one steerable wheel.

FIG. 3 is an illustration of vehicle movement in approaching-path mode.

FIG. 4 is an illustration of vehicle movement in line-acquisition mode.

FIG. 5 is an illustration of vehicle movement in on-line mode.

### DETAILED DESCRIPTION OF THE INVENTION

With reference to the accompanying Figures, there is provided a method and system for automatically steering a vehicle along an intended target path, wherein the system elements are architecturally partitioned within the system.

It is understood that the embodiments of the inventive system and methods disclosed herein have broad applicability to steerable vehicles generally including, inter alia, vehicles with at least one steerable wheel and vehicles with at least one steerable rudder or other steerable mechanism such as controllable tracks. Thus, exemplary vehicles that may benefit from application of various embodiments of the invention as disclosed and claimed herein include without limitation, agricultural sprayers, tractors, passenger cars and trucks, all-terrain vehicles, boats, personal watercraft and the like. Specific applications may include agricultural fieldwork such as cultivating, planting or spraying. Maintenance, i.e., mowing, spraying, seeding and aeration of golf course fairways or lawns, using turf maintenance equipment that is well known in the art is also within the purview of the present disclosure.

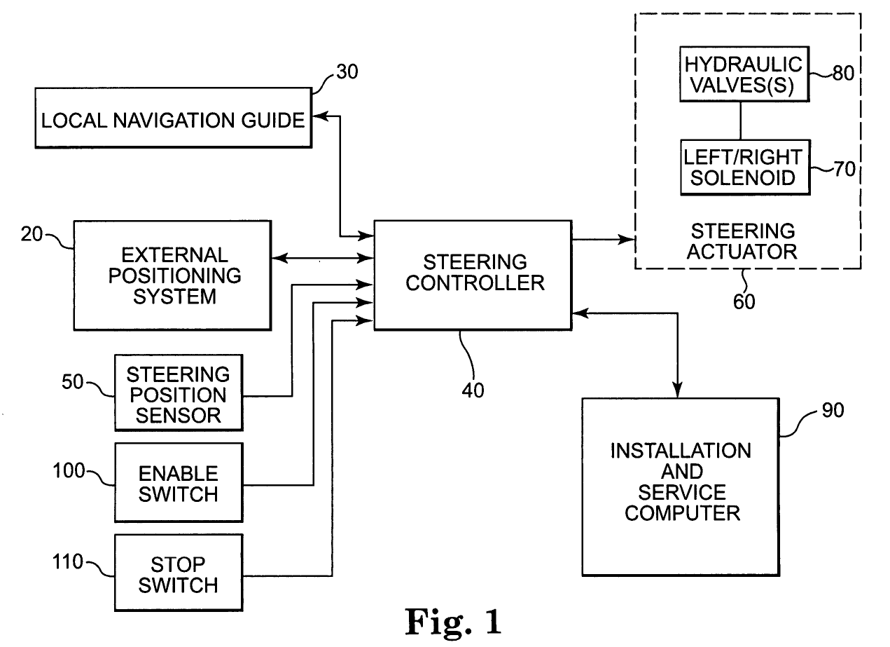

As illustrated in FIG. 1, the preferred embodiment for the system 10 comprises a number of system elements.

One embodiment of the system provides an external positioning system 20 that is in communication with a local navigation guidance unit 30 via communication switching in a steering controller 40. The preferred embodiment for the external positioning system 20 is a Global Positioning System (GPS) receiver that may be enabled to receive differential GPS (DGPS) signals and may be located on the vehicle.

An exemplary receiver that may provide submeter accuracy is found in the Invicta™ DGPS line of receivers provided by Raven Industries, Sioux Falls, S. Dak. However, the partitioned design of the inventive system allows virtually any GPS or DGPS-enabled receiver to be “plugged into” the system. This aspect of the invention is particularly advantageous as the technology regarding DGPS tracking solutions is continuously evolving and improving. The partitioned system 10 disclosed and claimed herein allows all currently existing DGPS-enabled receivers to be used within the system 10 while allowing future DGPS technology improvements or advancements to be easily integrated into the inventive system 10.

Thus, embodiments of the inventive system and method may include a differential global positioning satellite (DGPS) receiver located aboard the vehicle for receiving course acquisition code (C/A-code) signals transmitted at a frequency of 1575.42 MHz from orbiting GPS satellites.

Various embodiments of the system and method may utilize GPS and DGPS signals. However, the invention described herein is certainly not limited to GPS or DGPS signals. Any external positioning system 20 that provides real time positioning data will work within the system and is within the scope of the invention as will those skilled in the art readily recognize.

A particular embodiment may include an antenna (not shown) located on the vehicle for receiving signals from differential correction sources and GPS satellites. The receiver thus provides information regarding the geographical position of the vehicle, or more specifically, the geographical position of the antenna. In various embodiments, the DGPS signal source may be one or more of the following: WMS; HP Omnistar; Coast Guard Beacon; RTK; and Omnistar VBS.

The inventive embodiment utilizing the DGPS receiver transmits position solution data that may be in the form of vehicle position and course-over-ground, i.e., the navigational path traversed by the vehicle, including speed of the vehicle, to the local navigation guidance unit 30.

The local navigation guidance unit 30 may then compare the positional and/or course-over-ground solution data with the intended target path previously entered into the local navigation guidance unit 30 by the operator and stored within the unit's memory. A processor within the local navigation guidance unit 30 may then calculate guidance error comprising the level of offset from the intended target path as well as the angle error from the intended target path. The guidance error may be displayed graphically and/or numerically on an operator display interface disposed on the local navigation unit 30. In addition, safety warnings and/or safety indicators may be displayed by the local navigation unit 30.

The local navigation guidance unit 30 is located on the vehicle to be automatically steered. An embodiment of a local navigation guidance unit 30 may be a lightbar. Such lightbars are well known in the art, a description may be found in U.S. Pat. No. 6,104,979 to Starlink, Inc., a predecessor of the instant patent application's assignee Raven Industries. U.S. Pat. No. 6,104,979 is incorporated herein by reference. An exemplary lightbar that may be used in an embodiment of the system is the RGL 600 Smartbar™ manufactured and sold by Raven Industries Flow Control Division, 205 East Sixth Street, P.O. Box 5107, Sioux Falls, S. Dak. 57117.

The next system element is a steering controller 40 located on the vehicle and which is in communication with the local navigation guidance unit 30 and the external positioning system 20, more preferably, with the DGPS receiver. As described above, the steering controller 40 allows communication between the local navigation guidance unit 30 and the external positioning system 20. This communication between architecturally partitioned system components is facilitated by communication switching within the steering controller 40. An example of an embodiment of the steering controller 40 is the Smartrax™ controller available from Raven Industries, Inc., Sioux Falls, S. Dak.

The steering controller 40 receives the guidance error messages from the local navigation guide 30 periodically as the DGPS receiver 20 sends position solutions to the local navigation guide 30. The position solutions may be received at a rate of ten positions per second and is limited by current DGPS technology, though the steering controller 40 is capable of handling more frequent transmission of position solutions from the local navigation guide 30 . The steering controller's 40 control features are primarily synchronized with the reception of a guidance error message. The steering controller 40 may provide a display for displaying information relating to current system operation as well as safety warnings and/or safety indicators.

A steering position sensor (SPS) 50 may be located on the vehicle and may be in operative communication with the steering controller 40. The SPS 50 may recognize wheel angle, or other steering element angle, at center position and wheel angle positions left and right of center position and may be capable of monitoring the angle of the front wheels during vehicle operation. The SPS 50 may be calibrated to recognize wheel angle at center, extreme right and extreme left positions. The SPS 50 may be further capable of converting the position of the vehicle's steering element from an angle to a voltage. The steering controller 40 may receive this voltage from the SPS 50 and then, using the vehicle parameters and the SPS calibration (i.e. voltage at left, center, and right extremes), converts the voltage to an approximation of the angle of the front wheels. The most preferred SPS 50 is a linear variable resistor. Another SPS embodiment 50 comprises a rotary device that uses a Hall-effect sensor. It should be obvious to those skilled in the art that the inventive system as described above is applicable to a broad range of steering elements, e.g., inter alia, steerable wheels, rudders and tracks.

In vehicles wherein the steering element comprises controllable tracks, the position of the vehicle is determined by preferably a gyroscopic yaw rate sensor (not shown) mounted on the vehicle. The gyroscopic yaw rate sensor may be in communication with the steering controller 40, providing directional heading or angle information relative to the intended target path stored in the local navigation guide 30. Additional equivalent sensors will readily present themselves to those skilled in the art.

There may be at least one steering actuator 60 on the vehicle, the steering actuator 60 being in communication with, and controlled by, the steering controller 40 for adjusting the vehicle's steering mechanism along an intended target path. The steering actuator(s) 60 may comprise left and right solenoids 70. Depending upon the prevailing conditions, subject vehicle and contemplated uses for a particular embodiment, different solenoid configurations may be used. For example, the following solenoid configurations may be used in various embodiments of the invention: pulsed, SPS direct, on-off, or PWM. In addition, the at least one steering actuator may comprise at least one hydraulic valve 80. In one embodiment, the solenoid 70 is operationally connected to at least one hydraulic valve 80 in this embodiment. The at least one hydraulic valve 80 may then operationally connected to at least one steerable wheel or equivalent steering element. Using this mechanism, the steering angle or directional heading may be adjusted to minimize guidance error relative to the intended path.

Another objective of the steering actuator(s) 60 is to provide for smooth steering while minimizing the necessity for system tuning. Thus, one embodiment may include a system timer incorporated into the steering controller 40 that may actuate the solenoids 70 and, in turn, the at least one hydraulic valve 80 at predetermined intervals. In the preferred embodiment, the timer will initiate actuation of the solenoids at least once per millisecond to minimize jerking associated with steering corrections while also minimizing the distance or deviation from the intended path.

As indicated in FIG. 1, the major system elements, i.e., the local navigation guidance unit 30, the external positioning system 20 and the steering controller 40 are architecturally partitioned from one another within the system. This design allows the steering controller 40 to communicate with the external positioning system 20 and the local navigation guidance unit 30 as well as facilitating switching communication between the external positioning system 20 and the local guidance unit 30. Such partitioning allows independent design, independent maintenance, and independent upgrades to the system elements. In addition, such partitioning provides for variation of components within the system 10, e.g., virtually any DGPS receiver may be used in the system 10. This, in turn, allows for introduction of technologically advanced DGPS receivers into the system in the future.

Another system embodiment may include an installation and service computer 90. The preferred embodiment architecturally partitions the computer 90 with respect to the external positioning system 20, the local navigation guidance unit 30, and the steering controller 40.

If there is a malfunction with any of the system elements, it may be possible firstly to diagnose the malfunction from a remote location utilizing the installation and service computer 90. Once the source of the malfunction is located, and if such malfunction requires a replacement system element, i.e., local navigation guide 30, steering controller 40 or DGPS receiver 20 for example, the malfunctioning system element may simply be unplugged from the system 10 and a replacement element plugged into the system 10.

Moreover, if a system firmware upgrade becomes available, the upgrade may be done from a remote location, or alternatively locally with the vehicle, using the installation and service computer 90 using techniques well known in the art.

Additional system elements include an enable switch 100 that is in communication with the steering controller 40 and that enables the system 10, and a stop switch 110 in communication with the steering controller 40 that disables the system 10.

Various embodiments of the system and apparatus having been disclosed above, the operational method will now be described with reference to a preferred embodiment for an agricultural vehicle, e.g., a tractor with at least one steerable wheel.

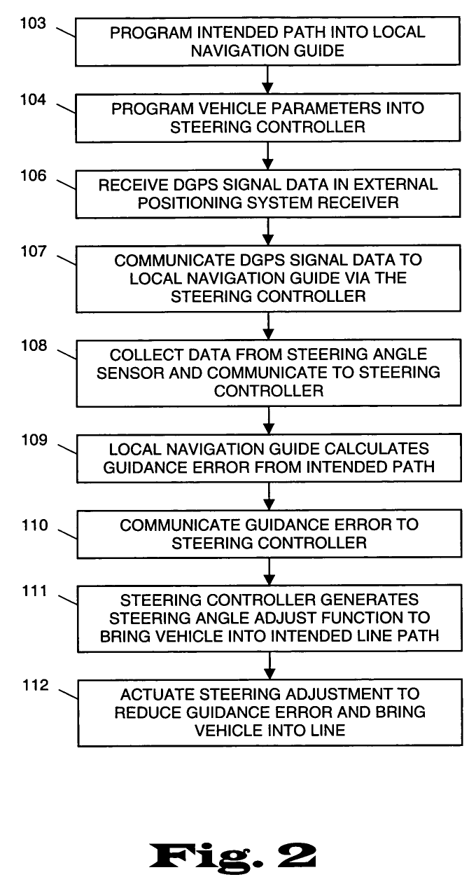

With reference now to FIG. 2, the general automatic steering process flow is illustrated with regard to a vehicle with at least one steerable wheel. The intended path is entered or programmed into the local navigation guide 103. Vehicle parameters, e.g., wheel base and boom width, are entered or programmed into the steering controller 104.

Meanwhile, DGPS signal data is received by the external positioning receiver 106. The DGPS signal data is then communicated from the external positioning receiver to the local navigation guidance unit via communication switching in the steering controller 107. While this is occurring, data is collected from the steering angle sensor in this embodiment and subsequently communicated to the steering controller 108. The local navigation unit calculates a guidance error indicating the deviation of the vehicle from the intended path 109 and communicates this deviation to the steering controller 110. The steering controller then generates a steering angle adjust function designed to automatically steer the vehicle back onto the intended path line and reduce deviation thereof 111. Ultimately, the steering angle adjust function is translated into actuation of a steering adjustment using, e.g., solenoids and associated hydraulic valves operationally connected to the steering element, to reduce the magnitude of the guidance error level 112.

More specifically, and with particular reference again to FIG. 1, the operator enters or programs the intended target path into a local navigation guide, e.g., a lightbar 30 mounted in operative view on the vehicle so that the operator may see safely see the display. The operator also enters or programs vehicle-specific parameters such as wheel base width and equipment boom width into the steering controller 40. The lightbar 30 is in operative communication with the steering controller 40 and with the external positional system, e.g., a DGPS receiver 20, via the communication switching in the steering controller 40. Since the steering controller 40 may also have a display in the preferred embodiment, it may be mounted so that the operator may view the display safely during operation.

The steering position sensor (SPS) 50 is mounted so that it may monitor the wheel angle of the exemplary tractor. Those skilled in the art will recognize a number of equivalent mounting positions and methods to achieve wheel angle, or other steering element, monitoring. In this manner, the SPS 50, which is in communication with the steering controller 40 is providing wheel angle data to the steering controller 40. The steering controller 40 may monitor the SPS at 5 millisecond intervals, or more frequently in various embodiments.

During the assisted-steering process, the DGPS receiver 20 is providing positional and course-over-ground solution data to the lightbar 30 via the communication switching in the steering controller 40. Meanwhile, the steering controller 40 is obtaining wheel angle data from the SPS 50 and providing the same to the lightbar 30. The lightbar 30 compares the intended target path with the positional and course-over-ground solution data, and calculates guidance error that may be displayed numerically and/or graphically on the lightbar 30. The guidance error may represent the level of offset from the intended target path as well as the angle error with regard to the intended path.

The lightbar 30 calculates and provides the guidance error data to the steering controller 40 as frequently as the DGPS receiver 20 sends position solutions to the lightbar 30. Currently, this is 10 positions per second, but the system 10 is capable of handling more or less frequent solution transmissions. Thus, the exemplary lightbar 30 provides guidance error messages to the steering controller 20 at a frequency of 10 per second.

When a guidance error message is received by the steering controller 20, a steering control function is executed that produces a steering angle adjust value and command that is based upon the SPS data, the programmed vehicle parameters and the guidance error data.

An exemplary tractor may have left and right solenoids 70 operationally connected to the steering controller 40 to allow assisted steering correction of the steering mechanism either in the right or left direction, depending upon the guidance error. The steering controller 40 uses the steering angle adjust value to actuate the solenoids 70 to reduce the magnitude of the guidance error. In turn, the solenoids 70 actuate hydraulic valves 80 that result in modification of the angle of the at least one steerable wheel.

Finally, an installation and service computer 90 may be provided to monitor the system's operation as well as diagnose and fix malfunctions or provide updated software. The steering controller 40 may send a data stream comprising its various functions described herein to the installation and service computer 90, including detailed guidance information. The computer 90 allows display of the guidance data in graphical form, along with systemic parameters. This data stream may be sent to a computer 90 that is remote from the roving vehicle or the data transfer may be accomplished locally. Such data may be used to monitoring and/or diagnosis of errors, malfunctions and the like. Similarly, the computer 90 may be used to transfer firmware and the like to correct malfunctions or to upgrade firmware either locally at the vehicle or from a location that is remote from the vehicle.

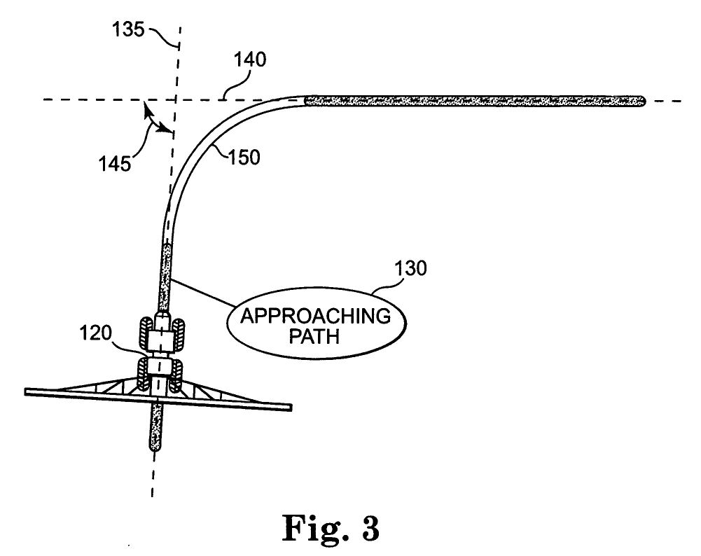

To more graphically illustrate an embodiment of the system and method, FIGS. 3-5 illustrate a tractor that acquires, approaches and eventually comes “on-line” with the intended target path, respectively. Thus, FIG. 3 provides a steerable-wheel tractor 120 is in approaching-path mode 130 wherein the tractor 120 is off the intended target path 140 and the vehicle is under the assisted steering system control as the tractor 120 is directed back toward the intended path 140. As may be seen in the Figure, the heading 135 of the tractor 120 is offset from the intended target path 140 at nearly a right angle 145. The inventive system and method allows the assisted vehicle to take the shortest pathway, given the vehicle parameters, to get back onto the intended target path 140 and in this example, given the heading 135 relative to the intended target path 140, the tractor will be steered to the right to acquire the line. The steering control parameters will remain essentially constant during the approaching-path mode 130 until the system determines that the vehicle should be turned more abruptly and enters the line-acquisition mode 150. The exact point in the sequence where line-acquisition mode 150 is entered depends upon the vehicle parameters such as speed, wheel base and turning radius.

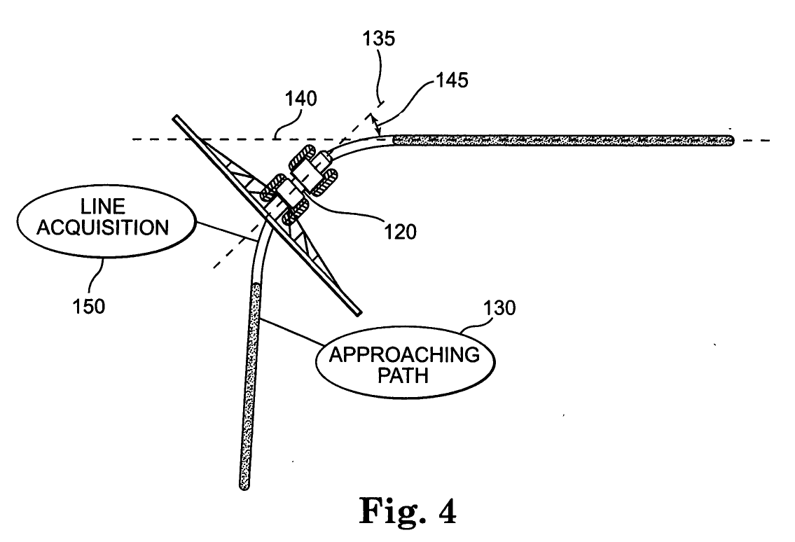

FIG. 4 illustrates the tractor in line-acquisition mode 150. Here, the system prompts the tractor 120 to begin turning more sharply in anticipation of going online with the intended target path 140. As may be seen in the Figure, the angle 145 between the vehicle's heading 135 and the intended target path 140 has significantly decreased, indicating that the heading 135 of tractor 120 is approaching the intended target path line 140.

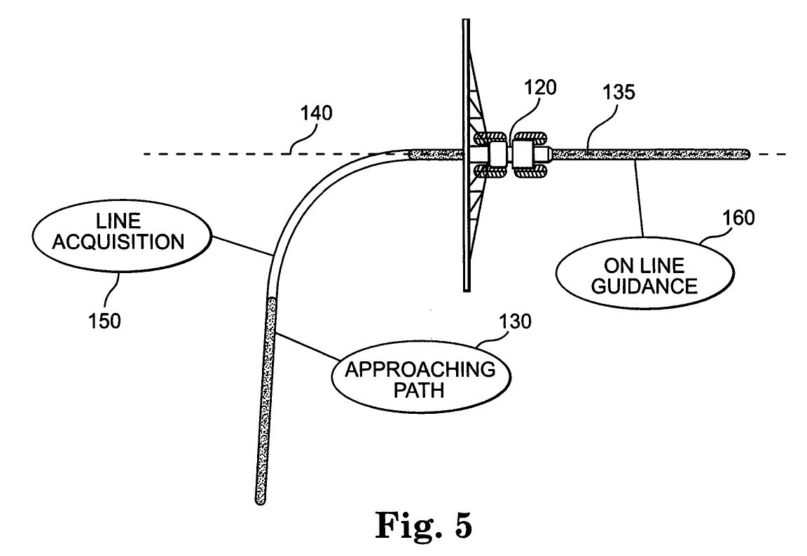

Ultimately, as seen in FIG. 5, the tractor 120 acquires the target path 140 and is in on-line mode 160. During this phase of operation, the system elements work to maintain the tractor 120 as closely to the intended target path 140 as possible. In other words, the system strives to minimize the offset error (distance of the vehicle from the intended target path) and angle error (offset of vehicle's heading from the intended target path). At the end of the current swath or intended target path 140, the operator will, in this embodiment, steer the tractor 120 around to the next programmed target path 140, the vehicle will automatically acquire the new intended target swath/path 140 and enter on-line mode 160. This process is repeated until the entire field has been covered and the programmed intended target path 140 has been satisfied.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A system for automatically steering a vehicle along an intended target path, the system comprising:
a local navigation guidance unit for establishing the intended target path and for calculating guidance error data therefrom, the local navigation guidance unit further having a memory wherein intended target path information for the vehicle is stored;
an external positioning system for providing position and course-over-ground solution data for the vehicle to the local navigation guidance unit; and
a steering controller in communication with the external positioning system and local navigation guidance unit for receiving the guidance error data, generating a steering signal that minimizes the guidance error and steering the vehicle in response to the steering signal,
wherein the local navigation guide, steering controller, and the external positioning system are architecturally partitioned within the system.

2. The system of claim 1, further comprising the steering controller allowing entry and storage of vehicle parameters.

3. The system of claim 1, further comprising the steering controller having communication switching capability that enables communication between the architecturally partitioned local navigation guide and the external positioning system.

4. The system of claim 1, wherein the local navigation guidance unit further comprises the capability of receiving position and course-over-ground solution data from the external positioning system via communication switching in the steering controller, comparing the position or course-over-ground solution data with the intended target path, calculating guidance error and sending guidance error messages to the steering controller.

5. The system of claim 4, further comprising the local navigation guidance unit sending guidance error messages to the steering controller with the same frequency as the external positioning system provides position and course-over-ground data to the local navigation guidance unit via communication switching in the steering controller.

6. The system of claim 5, wherein the position and course-over-ground data is provided by the external positioning system to the local navigation guidance unit via communication switching in the steering controller with a frequency of at least ten data transmissions per second.

7. The system of claim 1, further comprising a steering angle position sensor on the vehicle, wherein the steering angle position sensor is in communication with the steering controller and wherein the vehicle comprises at least one steerable wheel for changing the vehicle's heading.

8. The system of claim 7, further comprising the steering controller monitoring the steering angle position sensor with a frequency of at least once every five milliseconds.

9. The system of claim 7, wherein the steering angle position sensor is a linear variable resistor.

10. The system of claim 7, wherein the steering angle position sensor is a rotary device that uses a Hall-effect sensor.

11. The system of claim 7, further comprising at least one steering actuator on the vehicle and in communication with the steering controller and the at least one steerable wheel for automatically steering the vehicle in response to the steering signal.

12. The system of claim 11, wherein the steering signal urges the at least one steering actuator to steer the vehicle along the intended target path and to minimize the guidance error.

13. The system of claim 11, wherein the at least one steering actuator comprises right and left solenoids, the solenoids selected from the group consisting of pulsed, SPS direct, on-off, and PWM.

14. The system of claim 13, wherein the at least one steering actuator further comprises at least one hydraulic valve, the hydraulic valve operatively connected to, and controlled by, the solenoids.

15. The system of claim 14, wherein the solenoid is actuated by the steering controller at a rate of at least once per millisecond.

16. The system of claim 1, further comprising a gyroscopic yaw rate sensor on the vehicle, wherein the gyroscopic yaw rate sensor is in communication with the steering controller and wherein the vehicle comprises controllable tracks for changing the vehicle's heading.

17. The system of claim 1, wherein the local navigation guidance unit further comprises a display wherein the guidance error and safety warnings may be displayed.

18. The system of claim 1, wherein the steering controller further comprises a display wherein steering control information and safety warnings may be displayed.

19. The system of claim 1, wherein the vehicle further comprises at least one steering actuator on the vehicle and in communication with the steering controller; and at least one steerable rudder, the at least one rudder operationally connected to the at least one steering actuator for steering the vehicle in response to the steering signal.

20. The system of claim 1, wherein the vehicle is an agricultural vehicle with a definite working width for generation of at least one work path or swath over a field.

21. The system of claim 1, further comprising an installation and service computer in communication with the steering controller, wherein the installation and service computer is capable of wired or wireless communication with the steering controller and is architecturally partitioned from the steering controller, the local navigation guidance system and the external positioning system.

22. The system of claim 21, wherein the installation and service computer is capable of receiving data from the steering controller to aid in diagnosis of system malfunctions.

23. The system of claim 22, further comprising the diagnosis taking place at the location of the steering controller or at a location remote from the location of the steering controller.

24. The system of claim 1, wherein the external positioning system further comprises a receiver and an antenna located on the vehicle for receiving real-time positioning signals from a navigational system.

25. The system of claim 24, wherein the external positioning system further comprises GPS satellites and differential correction sources (DGPS).

26. The system of claim 25, wherein the source of the DGPS signal selected from the group consisting of WAAS, HP Omnistar, Coast Guard, RTK, and Omnistar VBS.

27. A system for automatically steering a vehicle along an intended target path, the system comprising:
a local navigation guidance unit for establishing the intended target path and for calculating guidance error data therefrom, the local navigation guidance unit further having a memory wherein intended target path information for the vehicle is stored;
an external positioning system for providing position and course-over-ground solution data for the vehicle to the local navigation guidance unit;
a steering controller in communication with the external positioning system and local navigation guidance unit for receiving the guidance error data, generating a steering signal that minimizes the guidance error and steering the vehicle in response to the steering signal, and wherein the local navigation guidance unit further comprises the capability of receiving position and course-over-ground solution data from the external positioning system via communication switching within the steering controller, comparing the position or course-over-ground solution data with the intended target path, calculating guidance error and sending guidance error messages to the steering controller;
a steering angle position sensor, wherein the steering angle position sensor is in communication with the steering controller for generating the steering signal and wherein the vehicle comprises at least one steerable wheel for changing the vehicle's heading;
at least one steering actuator comprising left and right solenoids in communication with the steering controller and the at least one steerable wheel, and at least one hydraulic valve, the at least one hydraulic valve operatively connected to, and controlled by, the solenoids, the at least one steering actuator automatically steering the vehicle along the intended target path in response to the steering signal; and
an installation and service computer in communication with the steering controller, wherein the installation and service computer is capable of wired or wireless communication with the steering controller and is capable of receiving data from the steering controller to aid in diagnosis of system malfunctions,
wherein the local navigation guide, steering controller, external positioning system and installation and service computer are architecturally partitioned within the system.

28. A method for automatically steering a vehicle with a steering mechanism along an intended target path:
entering an intended target path into a local navigation guidance unit located on the vehicle;
entering vehicle parameters into the steering controller;
receiving, with the local navigation guidance unit, position and course-over-ground data from an external positioning system, via communication switching in a steering controller, the data indicative of a path traversed by the vehicle, wherein the local navigation guidance unit is architecturally partitioned from the external positioning system;
comparing, by the local navigation guidance unit, the position or course-over-ground data with the intended target path to obtain guidance error; transmitting the guidance error from the local navigation guidance unit to the steering controller that is located on the vehicle and is architecturally partitioned from the local navigation guidance unit;
determining the angle of heading of the vehicle using a steering position sensor or by differentiation of the course-over-ground data;
generating, by the steering controller, a heading angle adjustment based on the intended target path, the navigational path traversed by the vehicle, the vehicle parameters, the steering angle and the guidance error; and
actuating the steering mechanism to maintain the vehicle along the intended target, path.
